(19) United States
(12) Patent Application Publication
(10) Pub. No.: US 2017/0213683 A1
(43) Pub. Date: Jul. 27, 2017

(54) APPARATUS AND METHOD FOR PREVENTING CONTAMINATION OF ACCELERATOR SYSTEMS BY AN ION PUMP

(71) Applicant: JEFFERSON SCIENCE ASSOCIATES, LLC, NEWPORT NEWS, VA (US)

(72) Inventor: Ganapati Rao Myneni, Yorktown, VA (US)

(21) Appl. No.: 15/412,020

(22) Filed: Jan. 22, 2017

Related U.S. Application Data
(60) Provisional application No. 62/287,227, filed on Jan. 26, 2016.

(51) Int. Cl. H01J 7/18; H01J 1/50; B01D 46/54

(52) U.S. Cl. CPC H01J 7/18; B01D 46/54; H01J 1/50; H05H 7/22

(57) ABSTRACT

An apparatus and method for preventing the contamination of sensitive accelerator surfaces and preventing deterioration of the accelerator field emission in a linear accelerator. The method includes providing a nanofilter at the inlet of the getter ion pumps connected to the beam line of the linear accelerator. The method includes providing a break in the inlet line, inserting a conflat flange at the break, and sandwiching the nanofilter between the two halves of the conflat flange. The nanofilter includes a maximum pore size of 3 nanometers, thereby preventing contaminants greater than 3 nanometers from flowing from the getter ion pump back to the accelerator system.

### CROSS-REFERENCE TO RELATED APPLICATIONS

This application claims the benefit of Provisional U.S. Patent Application Ser. No. 62/287,227 filed Jan. 26, 2016.

### GOVERNMENT LICENSE RIGHTS STATEMENT

The United States Government may have certain rights to this invention under Management and Operating Contract No. DE-AC05-06OR23177 from the Department of Energy.

### FIELD OF THE INVENTION

The present invention relates to cryogenic accelerator systems and more particularly to reducing contaminants from getter ion pumps used in such accelerator systems.

### BACKGROUND OF THE INVENTION

Elemental particles, such as electrons, ions, and protons, may be accelerated to relativistic speeds by a linear accelerator (linac). The linac typically includes a plurality of accelerating cavities that resonate at frequencies whose wavelengths are half integer multiples of the dimensions. At the right frequency, a resonant field can build up to store thousands (copper cavity) or millions (superconducting cavity) of times more energy than when off resonance. This is the fundamental foundation for accelerating structures that can develop gradients equivalent to millions of volts.

With reference to FIG. 1, a linac 20 may include one or more cryomodules 22 that may each include a plurality of accelerating cavities (not shown). A typical cryomodule is a mechanical assembly of 8 superconducting cavities, including 4 cavity pairs, in an insulating vacuum jacket 24. An electron beam 26 is transmitted through a beam line 28 and is accelerated by each of the cavities within the cryomodules 22. Liquid helium is circulated through the insulating vacuum jacket 24, a portion of which is shown, that surrounds the cryomodules and cools the temperature of the beam line 28 to 2.0 to 4.2 K. The beam line 28, which will provide a path for the accelerating electron beam 26, is maintained at ultra-high vacuum, typically at 10⁻⁴ to 10⁻¹² Torr. To maintain the ultra-high vacuum, one or more getter ion pumps 30 are typically connected by piping 32 to the beam line. External connections to the cryomodules may include RF waveguides, cryogenic lines, and instrumentation (not shown). Although residual gas species are typically pumped by the getter ion pump 30 toward the pump, or in the direction of arrow 34, contaminants oftentimes flow in the reverse direction 36, unfortunately contaminating the sensitive accelerator system surfaces.

Getter ion pumps are being used in cryogenic accelerator systems mostly for control/interlock purposes. Unfortunately getter ion pumps contaminate the sensitive accelerator system surfaces leading to deterioration of the accelerators by field emission. Accordingly, it would be beneficial to provide an apparatus and method for preventing contamination of the sensitive accelerator system surfaces of a linear accelerator by an ion pump.

### OBJECT OF THE INVENTION

A first object of the invention is to provide a method for preventing contamination of sensitive accelerator system surfaces by a getter ion pump.

A second object of the invention is to provide a method for reducing deterioration of the accelerators by field emission caused by operating of a getter ion pump.

A further object of the invention is to provide a contamination-free getter ion pump for to preventing backflow of contaminants to a vacuum system.

### SUMMARY OF THE INVENTION

The present invention provides a method for preventing the contamination of sensitive accelerator surfaces and preventing deterioration of the accelerator field emission in a linear accelerator. The method includes providing a nanofilter at the inlet of the getter ion pumps connected to the beam line of the linear accelerator. The method includes providing a break in the inlet line, inserting a conflat flange at the break, and sandwiching the nanofilter between the two halves of the conflat flange. The nanofilter includes a maximum pore size of 3 nanometers, thereby preventing contaminants greater than 3 nanometers from flowing from the getter ion pump back to the accelerator system.

### DESCRIPTION OF THE DRAWINGS

FIG. 1 depicts the layout of a conventional energy recovery linac.

FIG. 2 depicts the layout of an energy recovery linac according to the present invention, in which a nanofilter is installed in the inlet line to the getter ion pump in order to eliminate contamination of the linac beam line.

FIG. 3 depicts a detailed view illustrating the method of the present invention, in which a nanofilter is installed in the inlet line to the getter ion pump.

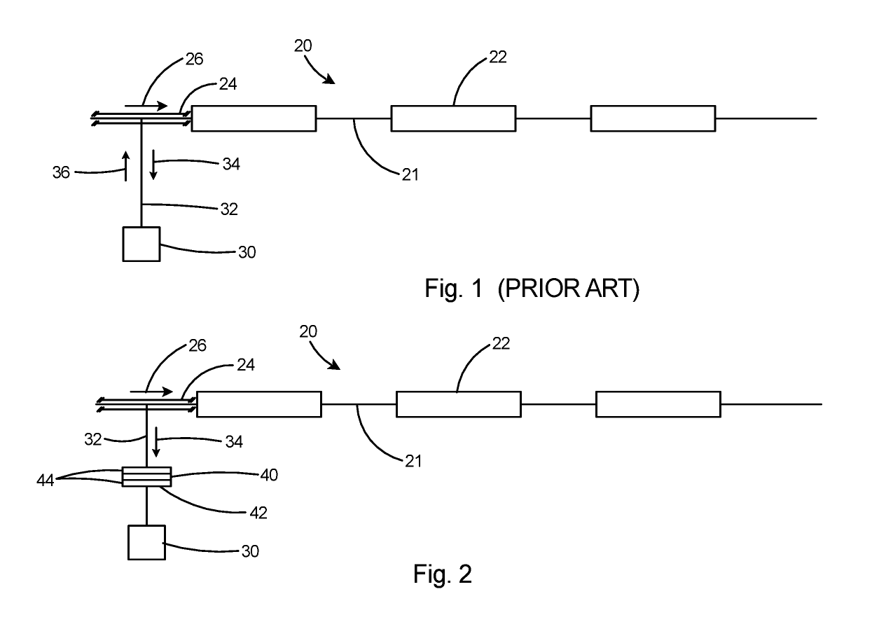

### DETAILED DESCRIPTION

The present invention provides a method for preventing the contamination of sensitive accelerator surfaces and preventing deterioration of the accelerator field emission in a linear accelerator. The method includes providing a nanofilter at the inlet of the getter ion pump.

Referring to FIG. 2, the present invention provides a method for preventing the contamination of sensitive accelerator surfaces and preventing deterioration of the accelerator field emission in a linear accelerator. The method includes providing a nanofilter 40 in the inlet piping 32 of the getter ion pump 30 connected to the beam line of the linac 22. As piping may be continuous, such as welded piping, the scope of the invention may include providing a break in the inlet line, inserting a conflat flange 42 at the break, and sandwiching the nanofilter 40 between the two flange halves 44 of the conflat flange. The nanofilter preferably includes a maximum pore size of 3 nanometers, thereby preventing contaminants greater than 3 nanometers from flowing from the getter ion pump 30 back to the accelerator system.

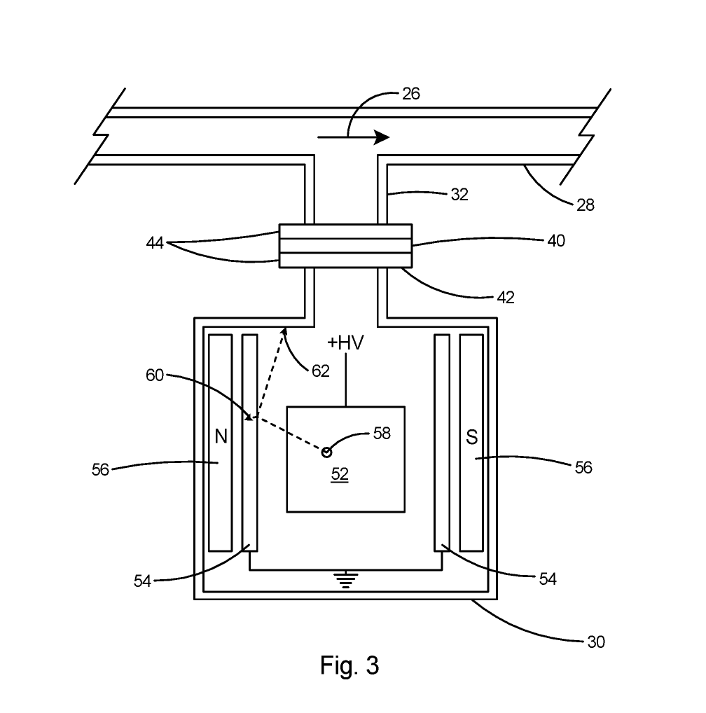

With reference to FIG. 3, the method of the present invention includes installing a nanofilter 40 in the inlet piping 32 of a getter ion pump 30 connected to the beam line of a linear accelerator 22. The getter ion pump 20 typically includes a pump housing 50, an anode 52, one or more cathodes 54, and two magnets 56 of reverse polarity. The anode 52 is electrically isolated from the pump housing 50 and typically has a positive voltage +HV, such as 6 kV, applied. The cathodes 54 are constructed of titanium and are at ground potential. A magnetic field is induced by permanent magnets 56. An electric discharge produces a cloud of electrons in the vicinity of the anode 52. The electrons 58 ionize incoming gas atoms and molecules. The resultant ions are accelerated to strike the cathodes 54, which are usually constructed of titanium. On impact with a cathode, the accelerated ions either become buried within the cathode 60 or sputter cathode material 62 onto the walls of the pump housing. Gas particles such as. N2, O2, CO, and CO2 tend to react with the cathode material and sputter a film onto the walls 64 of the pump housing. Inert and lighter gases, such as He and H₂ tend not to sputter and are absorbed by the pump housing walls 64. Unfortunately getter ion pumps contaminate the sensitive accelerator system surfaces leading to deterioration of the accelerators by field emission.

As shown in FIG. 3, addition of the nanofilter 40 to the inlet line 32 of the getter ion pump 30 effectively prevents contaminants from flowing from the getter ion pump 30 back to the accelerator system. The nanofilter 40 preferably includes a maximum pore size of 3 nanometers, thereby preventing contaminants greater than 3 nanometers from flowing from the getter ion pump 30 back to the accelerator system. Alternatively, the cathodes 54 may be constructed of tantalum or a combination of titanium and tantalum. The getter ion pump and nanofilter must be capable of withstanding the operating conditions of the accelerator system, which includes operable at a vacuum of 10⁻⁴ to 10⁻¹² Torr and at a temperature of 2.0 to 4.2 K.

As described hereinabove, a nanofilter can be added to the inlet of a conventional getter ion pump, also known as a non-evaporable getter (NEG), to prevent contaminants from flowing from the pump back to a vacuum system in a particle accelerator or any other vacuum system. Newer technology pumps using more chemically active metals, such as alkali and alkali-earth metals, can also be improved by adding a nanofilter at the inlet of the pump to prevent backflow of contaminants to the vacuum system.

Although the description above contains many specific descriptions, materials, and dimensions, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A contamination-free ion pump for preventing the contamination of an accelerator system, comprising:
a getter ion pump including inlet piping; and
a nanofilter installed in the inlet piping.

2. The contamination-free ion pump of claim 1 wherein the nanofilter further comprises a maximum pore size of 3 nanometers.

3. The contamination-free ion pump of claim 1 further comprising:
a conflat flange including two flange halves in the inlet piping; and
the nanofilter is sandwiched between the two flange halves of the conflat flange.

4. The contamination-free ion pump of claim 1 wherein said getter ion pump further comprises a pump housing, an anode, one or more cathodes, and two magnets of reverse polarity.

5. The contamination-free ion pump of claim 4 wherein the cathodes are constructed of titanium, tantalum, or a combination of titanium and tantalum.

6. The contamination-free ion pump of claim 4 wherein the anode is electrically isolated from the pump housing and has a positive voltage applied.

7. The contamination-free ion pump of claim 6 wherein the positive voltage applied to the anode is 6 kV.

8. The contamination-free ion pump of claim 1 wherein the getter ion pump and nanofilter are operable at a vacuum of 10⁻⁴ to 10⁻¹² Torr.

9. The contamination-free ion pump of claim 1 wherein the getter ion pump and nanofilter are operable at a temperature of 2.0 to 4.2 K.

10. A contamination-free ion pump for preventing the contamination of an accelerator system, comprising:
a getter ion pump including inlet piping;
a nanofilter installed in the inlet piping; and
the nanofilter including a maximum pore size of 3 nanometers.

11. The contamination-free ion pump of claim 10 further comprising:
a conflat flange including two flange halves in the inlet piping; and
the nanofilter is sandwiched between the two flange halves of the conflat flange.

12. The contamination-free ion pump of claim 10 wherein said getter ion pump further comprises a pump housing, an anode, one or more cathodes, and two magnets of reverse polarity.

13. A contamination-free ion pump for preventing the contamination of an accelerator system, comprising:
a getter ion pump including inlet piping;
a nanofilter installed in the inlet piping;
the nanofilter including a maximum pore size of 3 nanometers; and
a chemically active metal in said getter ion pump.

14. The contamination-free ion pump of claim 13 wherein said chemically active metal in said getter ion pump is selected from the group consisting of alkali and alkali-earth metals.

15. A method for preventing the contamination of sensitive accelerator surfaces and preventing deterioration of the accelerator field emission in a linear accelerator, comprising:
a linear accelerator including a cryomodule at an ultra-high vacuum;
an ion pump including inlet piping;
providing a break in the inlet piping;
installing a conflat flange at the break in the inlet piping; and
sandwiching a nanofilter between the two flange halves of the conflat flange.

16. The method of claim 15 wherein the nanofilter has a maximum pore size of 3 nanometers.

17. The method of claim 15 wherein the ultra-high vacuum is 10⁻⁴ to 10⁻¹² Torr.

18. The method of claim 15 further comprising an insulating vacuum jacket.

19. The method of claim 15 further comprising:
circulating liquid helium through the insulating vacuum jacket 24; and
said liquid helium cooling the cryomodule to 2.0 to 4.2 K.

20. The method of claim 15 further comprising a chemically active metal in said getter ion pump wherein said chemically active metal is selected from the group consisting of alkali and alkali-earth metals.
